(19) United States
(12) Patent Application Publication
(10) Pub. No.: US 2016/0072769 A1
(43) Pub. Date: Mar. 10, 2016

(54) NETWORK VERIFICATION DEVICE, NETWORK VERIFICATION METHOD, AND PROGRAM

(71) Applicant: NEC CORPROATION, Tokyo (JP)

(72) Inventors: Yutaka YAKUWA, Tokyo (JP); Nobuykui TOMIZAWA, Tokyo (JP)

(21) Appl. No.: 14/783,075

(22) PCT Filed: Apr. 9, 2014
(86) PCT No.: PCT/JP2014/060252

§ 371 Date: Oct. 7, 2015

(30) Foreign Application Priority Data
Apr. 10, 2013 (JP) 2013-081886

(51) Int. Cl. H04L 29/06

(52) U.S. Cl. CPC H04L 63/0281; H04L 63/0227

(57) ABSTRACT

In order to contribute to the improvement in the efficiency of an exhaustive verification of a network, a network verification device is provided with: a verification information input unit which accepts an input of verification information that defines the configuration of a network to be verified and the operation model of a device included in the network; a model checking execution unit which, in model checking using the verification information, performs a state transition without concretely dealing with the contents of a packet from a terminal connected to the network, sends information relating to the past transition path of each state to a search necessity/unnecessity confirmation unit before a state search of a next state, and performs the model checking while inquiring whether or not the search of the next state can be omitted or not; the search necessity/unnecessity confirmation unit which, based on the information relating to the past transition path of the state and received from the model checking execution unit, determines whether or not the search of the next state can be omitted, and responds as to whether or not the search of the next state can be omitted; and a verification result output unit which, based on an output from the model checking execution unit, outputs the result of a verification.

### DESCRIPTION ABOUT RELATED APPLICATION

The present invention is based on Japanese Patent Application: Japanese Patent Application No. 2013-081886 (filed on Apr. 10, 2013), and it is to be understood that the entire description contents of the same application is incorporated herein by reference.

### TECHNICAL FIELD

The present invention relates to a network verification device, a network verification method, and a program, and more particularly, to a network verification device, a network verification method, and a program for performing verification by making a network to be verified into a model.

### BACKGROUND ART

In operation management of a network, a technique called OpenFlow attracts attention. (see NPLs 1 and 2). The OpenFlow also attracts attention as a technique for realizing a concept of Software-Defined Network (hereinafter referred to as “SDN”). The SDN is a new paradigm in the field of the network for centrally managing a network control in accordance with a programmable method, and more particularly, the OpenFlow attracts various kinds of expectations such as automation, improvement of efficiency, reduction of power consumption, and the like of network operation.

On the other hand, in the OpenFlow, although the flexibility of the network control increases, there is a fear in that a problem may occur because of the increase of the network control. For example, problems increase due to an omission of consideration by a developer and a failure by a combination of multiple programs. Therefore, for stable operation of OpenFlow network, it is important to verify whether the network is safe or not in advance. For example, NPL 3 discloses a tool called “NICE” that performs state search of an OpenFlow network with a model checking. According to NPL 3, “NICE” symbolically executes a program of an OpenFlow controller (symbolically execute), derives a set of representative values of packets for executing all the code paths, and uses the set to perform the state search.

### CITATION LIST

### Non Patent Literature

NPL1: Nick McKeown and six other people, “OpenFlow: Enabling Innovation in Campus Networks”, [online], [searched on March 25, Heisei 25 (2013)], the Internet <URL: http://www.openflow.org/documents/openflow-wp-latest.pdf>
NPL 2: “OpenFlow Switch Specification” Version 1.0.0. (Wire Protocol 0x01), [online], [searched on March 25, Heisei 25 (2013)], the Internet <URL: https://www.opennetworking.org/images/stories/downloads/specification/o penflow-spec-v1.0.0.pdf>
NPL 3: Marco Canini and four other people, “A NICE Way to Test OpenFlow Applications”, [online], [searched on March 25, Heisei 25 (2013)], the Internet <URL: http://infoscience.epfl.ch/record/170618/files/nsdi-final.pdf>

### SUMMARY OF INVENTION

### Technical Problem

The following analysis is given by the present invention. The problems of the method represented by NPL 3 include inability to exhaustively verify main operation of the OpenFlow network with a realistic cost (time and machine resource) or not performing exhaustive verification (because of inability to perform the exhaustive verification with a realistic cost).

For example, in the technique disclosed in NPL 3, exhaustive verification is performed to verify all the code paths of the program of the OpenFlow controller. However, exhaustive verification is not performed to cover operation of the OpenFlow network affected by the program (transfer operation of communication packets by the OpenFlow switches and the like). For this reason, a problem related to main operation of the OpenFlow network may not be detected.

The above problem is not unique to the OpenFlow of NPLs 1, 2, and can be commonly involved in applicable to networks called SDN.

It is an object of the present invention to provide a network verification device, a program, and, a method capable of contributing to the improvement in the efficiency of an exhaustive verification of a network typically represented by an SDN.

### Solution to Problem

According to a first viewpoint, a network verification device is provided. The network verification device includes:

a verification information input unit that receives an input of verification information that defines a configuration of a network to be verified and an operation model of a device included in the network;

a model checking execution unit which, in a model checking using the verification information, performs a state transition without concretely dealing with a content of a packet from a terminal connected to the network, sends information relating to a past transition path of each state to a search necessity/unnecessity confirmation unit before a state search of a subsequent state, and performs the model checking while inquiring whether or not the search of the subsequent state can be omitted or not

the search necessity/unnecessity confirmation unit which, based on the information relating to the past transition path of the state and received from the model checking execution unit, determines whether or not the search of the subsequent state can be omitted, and responds as to whether or not the search of the subsequent state can be omitted; and

a verification result output unit which, based on an output from the model checking execution unit, outputs a result of a verification.

According to a second viewpoint, a network verification method is provided. The network verification method includes:

a step of receiving an input of verification information that defines a configuration of a network to be verified and an operation model of a device included in the network;

a step of performing a model checking by performing a state transition without concretely dealing with a content of a packet from a terminal connected to the network by using the verification information; and

a step of outputting a verification result of a network to be verified based on a result of the model checking.

A determination is made as to whether search of the subsequent state can be omitted or not based on information relating to a past transition path of each state before a state search of a subsequent state in the model checking, and the search of the state that is determined to be able to be omitted is omitted.

The method is related to a specified implement that is a device (the network verification device) which performs the model checking of the network to be verified.

According to a third viewpoint, a program is provided.

The program causes a computer to execute:

processing for receiving an input of verification information that defines a configuration of a network to be verified and an operation model of a device included in the network;

processing for performing a model checking by performing a state transition without concretely dealing with a content of a packet from a terminal connected to the network by using the verification information;

processing for outputting a verification result of a network to be verified based on a result of the model checking; and

further, processing for making a determination as to whether search of each state can be omitted or not based on information relating to a past transition path of each state before a state search of a subsequent state in the model checking, and omitting the search of the state that is determined to be able to be omitted.

The program can be stored in a (non-transitory) computer readable storage medium. That is, the present invention may also be realized as a computer program product.

### Advantageous Effects of Invention

The present invention can contribute to the improvement in the efficiency of an exhaustive verification of a network typically represented by an SDN.

### BRIEF DESCRIPTION OF DRAWINGS

FIG. 1 is a figure illustrating a configuration of an exemplary embodiment according to the present invention.

FIG. 2 is a figure illustrating a configuration of a network verification device of a first exemplary embodiment of the present invention.

FIG. 3 is a figure illustrating an example of configuration information about a network (topology information) which is input to a network verification device of the first exemplary embodiment of the present invention.

FIG. 4 is an example of an operation model of an OpenFlow switch of NPL 2.

FIG. 5 is an example of an operation model of an OpenFlow controller of NPL 2.

FIG. 6 is a figure illustrating an example of a description format of an operation model of a terminal used in a network verification device of the first exemplary embodiment of the present invention.

FIG. 7 is a figure illustrating an example of a constraint satisfaction problem used in the network verification device of the first exemplary embodiment of the present invention.

FIG. 8 is a figure illustrating an operation of the network verification device of the first exemplary embodiment of the present invention

FIG. 9 is a sample code indicating model checking with the network verification device according to the first exemplary embodiment of the present invention.

FIG. 10 is a flowchart equivalent to FIG. 9.

FIG. 11 is a sample code indicating model checking shown as a reference example.

FIG. 12 is a figure illustrating an example of constraint information corresponding to the packet in the first line of FIG. 6.

FIG. 13 is a figure illustrating, in the model checking of the network verification device of the first exemplary embodiment of the present invention, an example of a matching rule of a flow entry held at the side of the switch and an example of constraint information during the state transition caused by hit of this matching rule.

FIG. 14 is a figure illustrating, in the model checking of the network verification device of the first exemplary embodiment of the present invention, an example of a matching rule of a flow entry held at the side of the switch and an example of constraint information during the state transition of a Packet-In message.

FIG. 15 is a figure illustrating an example of an operation step caused by a program execution on a controller used in the model checking of the network verification device of the first exemplary embodiment of the present invention, and an example of constraint information corresponding to this operation step.

FIG. 16 is a figure for explaining deriving processing of a transition destination state in the model checking of the network verification device of the first exemplary embodiment of the present invention

FIG. 17 is an example of an operation model of a network device that is assumed in a second exemplary embodiment of the present invention.

FIG. 18 is a figure illustrating a configuration of a network verification device according to a third exemplary embodiment of the present invention.

### DESCRIPTION OF EMBODIMENTS

First, an overview of an exemplary embodiment of the present invention will be explained with reference to drawings. It should be noted that drawing reference symbols attached to the overview are given to the elements for the sake of convenience as an example for understanding, and they are not intended to limit the present invention into the aspects shown in the drawings.

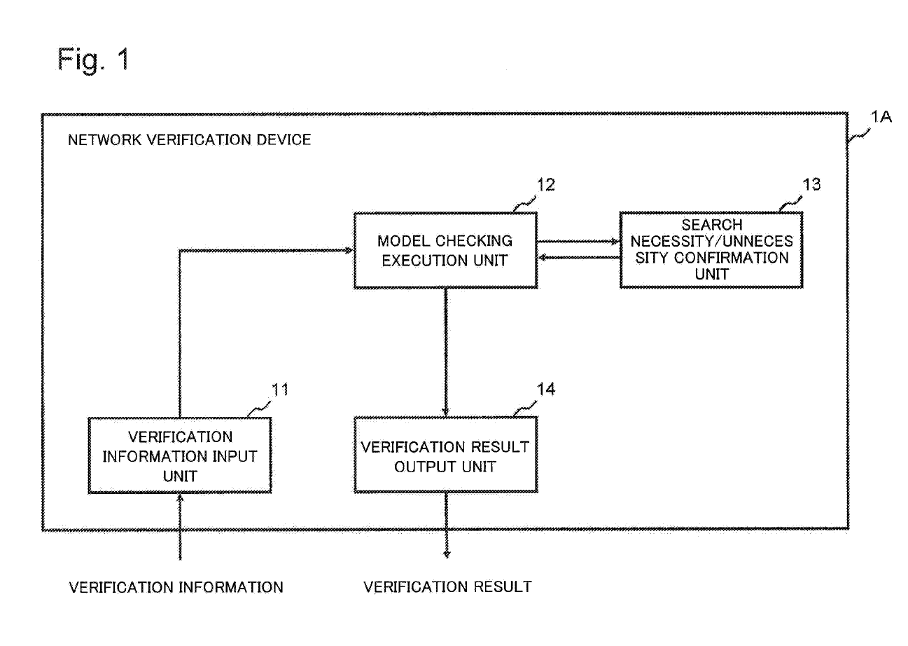

In an exemplary embodiment, as shown in FIG. 1, the present invention can be realized by a network verification device including a verification information input unit 11 which receives an input of verification information defining a configuration of a network to be verified and an operation model of a device included in the network, a model checking execution unit 12 which performs model checking using the verification information, a search necessity/unnecessity confirmation unit 13, and a verification result output unit 14 which outputs a result of a verification on the basis of an output from the model checking execution unit.

More specifically, the model checking execution unit 12 performs a state transition without concretely dealing with the contents of a packet from a terminal connected to the network in the model checking using the verification information. Further, the model checking execution unit 12 performs the following as a measure for not concretely dealing with the contents of a packet. More specifically, the model checking execution unit 12 sends information relating to the past transition path of each state to the search necessity/unnecessity confirmation unit 13 before a state search of a next state, and performs the model checking while inquiring whether or not the search of the next state can be omitted or not. In this case, “past transition path of state” means a path constituted by one or more “states” transited before any given “state” attains the “state”.

On the other hand, the search necessity/unnecessity confirmation unit 13 determines whether or not the search of the next state can be omitted on the basis of the information relating to the past transition path of the state and received from the model checking execution unit, and responds as to whether or not the search of the state can be omitted.

With the configuration as described above, this network verification device performs model checking without concretely dealing with the contents of a packet, and omits searching of the unnecessary state at that occasion. Therefore, exhaustive verification can be executed efficiently.

### First Exemplary Embodiment

Subsequently, the first exemplary embodiment of the present invention, in which the network to be verified is considered to be a network controlled by OpenFlow as shown in NPLs 1, 2, will be explained in details with reference to drawings.

[Explanation about Configuration]

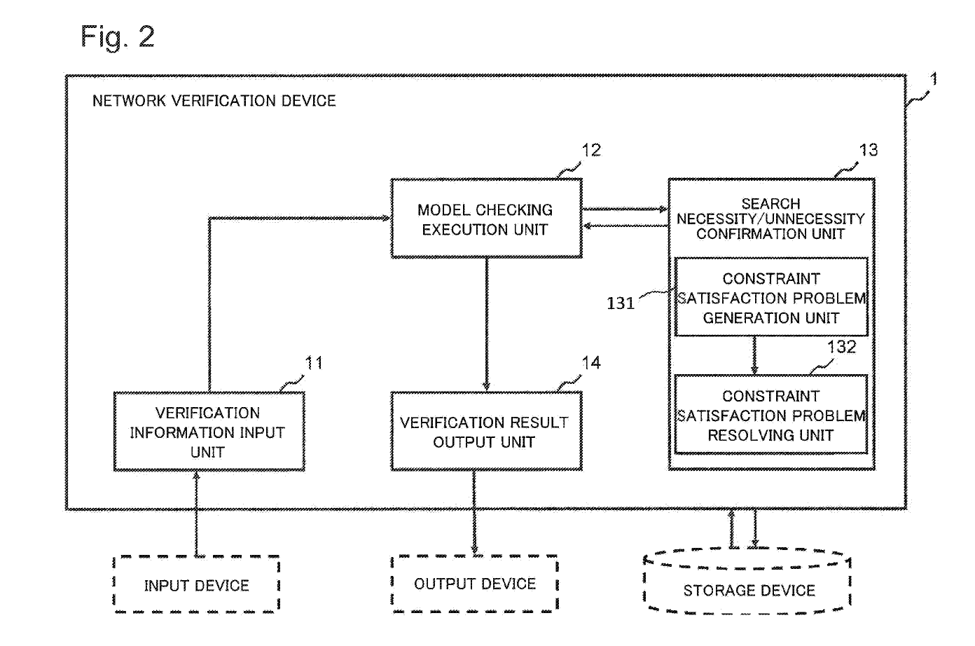

FIG. 2 is a figure illustrating a configuration of a network verification device of the first exemplary embodiment of the present invention. FIG. 2 shows a network verification device 1 including a verification information input unit 11 which receives verification information from an input device and sends it to a model checking execution unit 12, a model checking execution unit 12 which executes a model checking by exchanging information with a search necessity/unnecessity confirmation unit 13 with each other and sends the result of the model checking to a verification result output unit 14, a search necessity/unnecessity confirmation unit 13 which determines whether the search of the state is necessary or not by referring to the content stored in a storage device, and the verification result output unit 14 which outputs the verification result to an output device.

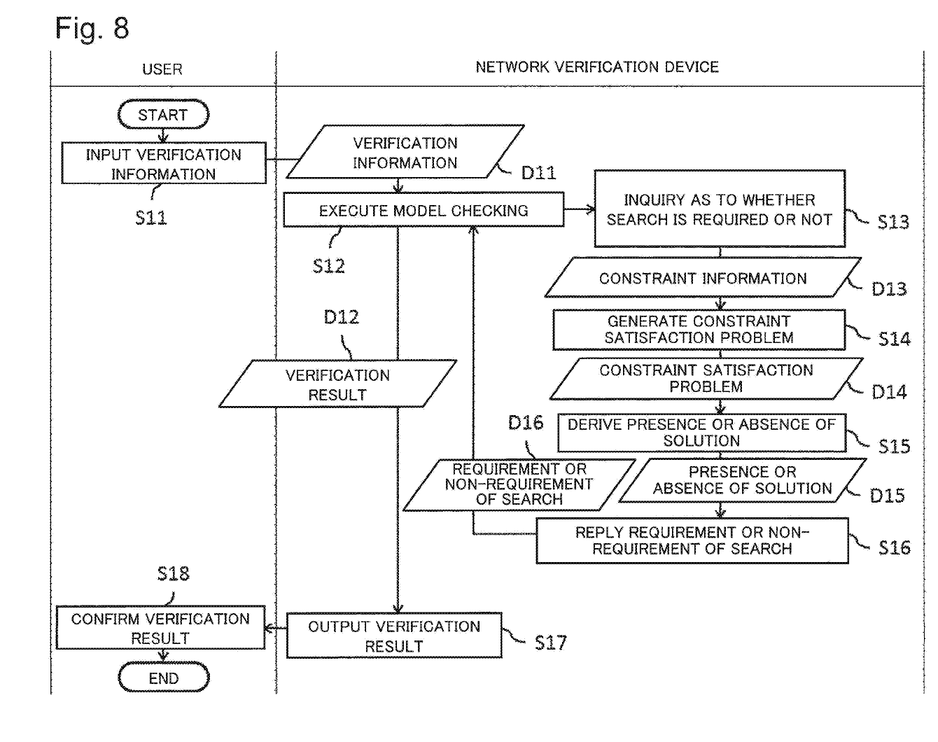

The verification information input unit 11 receives, as an input, verification information D11 (see FIG. 8) for defining a connection relationship of all the terminals, switches, and controllers constituting the network, each operation model of the terminal and the controller, and a property that is to be satisfied by the network. The verification information input unit 11 gives them to the model checking execution unit 12.

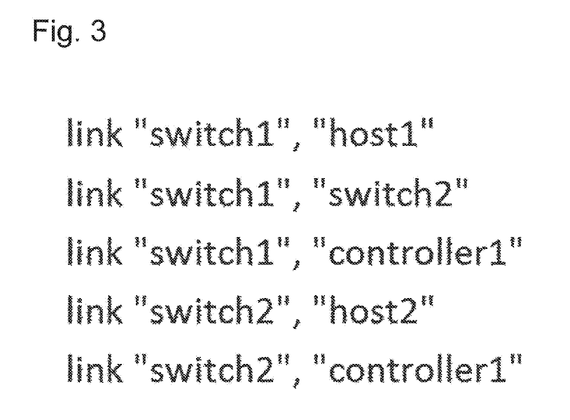

FIG. 3 is an example of topology information representing the connection relationship of the terminals, switches, and controllers received by the verification information input unit 11. For example, the entry in the first line indicates that a switch 1 (switch1) and a host 1 (host1) are connected. The topology information of FIG. 3 represents a configuration in which two switches connected to the same controller (controller1) are connected to each other, and are connected to hosts (host1, host2), respectively. It should be noted that the description format of the connection relationship is not limited to the format as shown in FIG. 3 explained above.

Subsequently, the “operation model” will be explained. In the first exemplary embodiment of the present invention, the network is controlled according to the OpenFlow of NPL 2, and the switches and the controller are considered to be based on the specification of the OpenFlow.

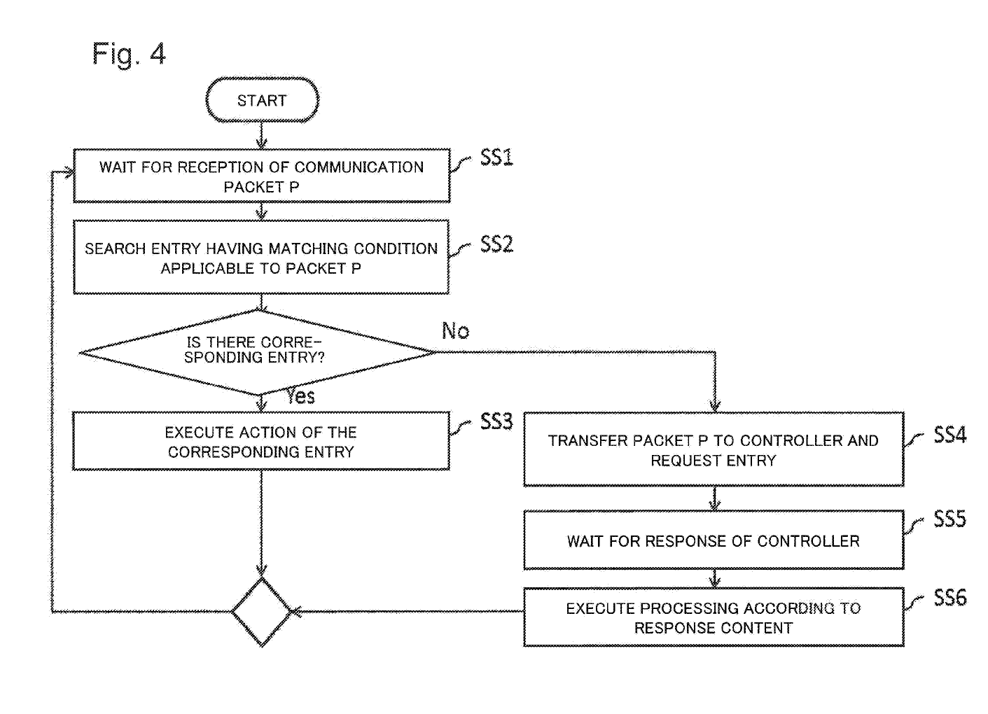

For this reason, the operation specification of the switch is as shown in FIG. 4. More specifically, the switch waits for reception of a communication packet (step SS1), and searches an entry having a matching condition applicable to the received communication packet from among the flow entries already installed to the switch itself (step SS2). In this case, when there is an applicable flow entry, the content of the action field is executed (step SS3), and when there is no applicable flow entry, the communication packet is transferred to the controller and inquires the processing content (step SS4). In a case where the controller is inquired of the processing content, the switch waits for a response of the controller (step SS5), and executes processing in accordance with a response content (step SS6). The above is considered to be repeated, and the entire processing is executed on the basis of this.

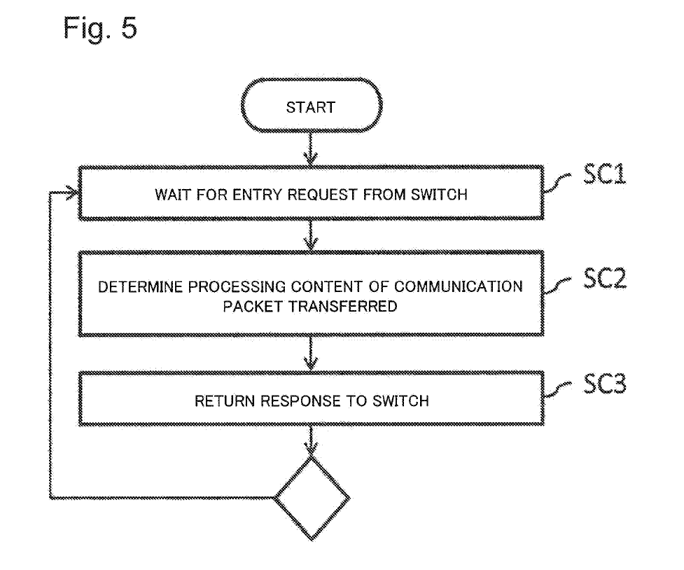

The operation model of the controller which is input with the verification input unit is in accordance with the specification of the OpenFlow. The operation model is to define what kind of operation is executed as an event handler in a case where an OpenFlow message is received. For example, the operation model includes a definition of an operation (handler) where a reception of a Packet-In message (an inquiry from a switch) is an event (for example, see FIG. 5). The operation model is individually for each type of OpenFlow message. However, it is not necessary to prepare the operation models for all the types. In a case where an operation model corresponding to any given OpenFlow message is not defined, processing is performed while it is assumed that an operation model defining a default operation specified in the OpenFlow specification is given.

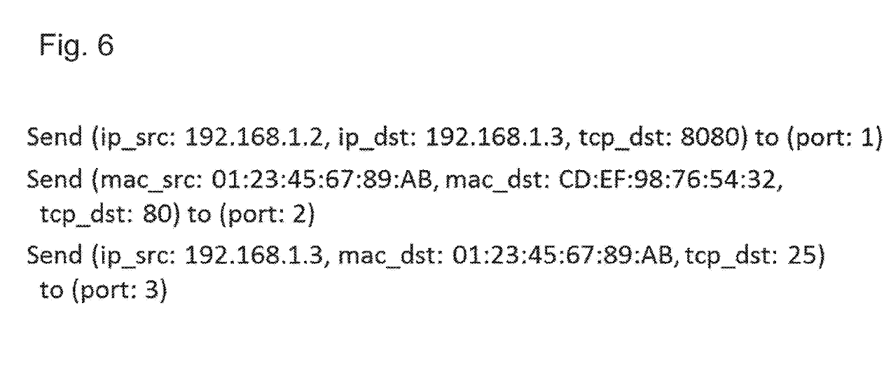

The operation model of the terminal is considered to be defined as an operation sequence where what kind of content a packet has and where the packet is transmitted are adopted as units of operations. A content of a packet to be defined is what can be designated in a matching field of the OpenFlow, and which are, for example, a destination MAC (Media Access Control) address of a packet and the like. The definition of the content of the packet may be partial, and, for example, only a destination MAC address may be defined. In the description format of the operation model of the terminal, the format is not limited as long as it can be processed in a mechanical manner, and for example, the description format of the operation model of the terminal is considered to be described in a format as shown in FIG. 6. In the example of FIG. 6, a part of the transmission packet of the terminal (header) is defined. For example, the entry in the first line of FIG. 6 indicates that an operation for transmitting, from port 1, a packet of which transmission source IP address is 192.168.1.2, of which destination IP address is 192.168.1.3, and of which destination port number of TCP is 8080.

The operation model is respectively defined for each terminal and controller included in the network. However, individual definitions for those performing the same operation may be omitted by referring to the same operation model. In the description format of the operation model, the format is not limited as long as it can be processed in a mechanical manner. For example, it may be written in a state transition diagram, a particular programming language, and the like. In the explanation about this case, the description format of the operation model is considered to be in accordance with the OpenFlow 1.0.0, but no problem would be caused if the description format of the operation model is based on an OpenFlow specification of other versions as long as the network verification device can appropriately handle the description format of the operation model.

In the verification information D11, the property may not be necessarily defined. In a case where the property is not defined, a typical property is verified, and thereafter, the entire network verification device performs an operation in such a manner as if the typical property is defined in the verification information D11.

The model checking execution unit 12 uses the verification information D11 given by the verification information input unit 11 to execute the model checking. Then, the model checking execution unit 12 outputs the verification result D12 including whether the property is satisfied or not and a counter example indicating that the property is not satisfied in a case where the property is not satisfied, and gives the verification result D12 to the verification result output unit 14. In addition, the model checking execution unit 12 holds the constraint information D13 required for making a determination as to whether it is necessary to perform search of each state, and during the state search, the model checking execution unit 12 gives the constraint information D13 of the state to be searched to the search necessity/unnecessity confirmation unit 13, and requests confirmation as to whether it is necessary to perform the search or not.

The search necessity/unnecessity confirmation unit 13 includes a constraint satisfaction problem generation unit 131 and a constraint satisfaction problem resolving unit 132.

The constraint satisfaction problem generation unit 131 generates a constraint satisfaction problem D14 for determining whether a search path in which a state to be searched has passed in the past could actually occur or not from the constraint information D13 given by the model checking execution unit 12.

The constraint satisfaction problem resolving unit 132 solves the constraint satisfaction problem D14, and drives a solution. In a case where the solution is derived, the transition path could actually occur, and therefore, the constraint satisfaction problem resolving unit 132 returns a reply indicating that “search is required” to the model checking execution unit 12. On the other hand, in a case where the solution is not derived, the transition path could not actually occur, and therefore, the constraint satisfaction problem resolving unit 132 returns a reply indicating that “search is not required” to the model checking execution unit 12.

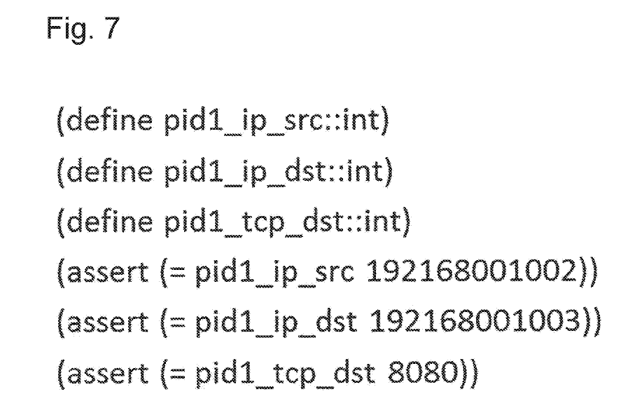

Hereinafter, the “constraint satisfaction problem” will be explained. The constraint satisfaction problem D14 is described in an input format of the constraint satisfaction problem resolving unit 132. For example, in a case where the constraint satisfaction problem resolving unit 132 uses Yices (Ver. 1.0.37) of the SMT (Satisfiability Modulo Theories) solver, the constraint satisfaction problem is described as shown in FIG. 7.

The constraint information D13 by itself may be the constraint satisfaction problem D14. For example, when the model checking execution unit 12 is in the state search, the constraint information D13 held in the state may be held in the format of the input language of the constraint satisfaction problem resolving unit 132. Then, such constraint information D13 may be configured to be given to the search necessity/unnecessity confirmation unit. In this case, the constraint satisfaction problem generation unit 131 is unnecessary, and therefore, the constraint satisfaction problem generation unit 131 may be removed from the search necessity/unnecessity confirmation unit 13. Then, when the model checking execution unit 12 inquires of the search necessity/unnecessity confirmation unit 13, the constraint information D13 (=constraint satisfaction problem D14) may be directly given to the constraint satisfaction problem resolving unit 132.

The verification result output unit 14 outputs the verification result D12, which is the output of the model checking execution unit 12, in an appropriate form on a display and the like.

Each unit (processing means) of the network verification device 1 as shown in FIG. 2 can be achieved by a computer program for causing a computer constituting the network verification device to execute each of the above processing using the hardware.

[Explanation about Operation]

Subsequently, an operation of the first exemplary embodiment of the present invention will be explained in details. FIG. 8 is a figure illustrating an operation of a network verification device of the first exemplary embodiment of the present invention. As shown in FIG. 8, the user generates the verification information D11, and inputs the verification information D11 to the verification information input unit 11 (step S11).

The model checking execution unit 12 executes the model checking by using the verification information D11 which is input with the verification information input unit 11, and generates the verification result D12 including whether the property is satisfied or not and a counter example indicating that the property is not satisfied in a case where the property is not satisfied. Then, the model checking execution unit 12 gives the verification result D12 to the verification result output unit 14 (step S12). In the model checking, the model checking execution unit 12 does not hold a concrete content of a packet, and performs state transition without depending on the content. However, the model checking execution unit 12 holds the constraint that is to be satisfied during the transition, as the constraint information D13, in the state of the transition destination. The state holds, for all the transitions (transition paths) in the past up to the state itself, the constraint information thereof.

When the state search is performed, to determine whether the search is required or not (whether the transition path could actually occur or not), the model checking execution unit 12 sends the constraint information D13 possessed by the state to the search necessity/unnecessity confirmation unit 13, and inquires whether the search is required or not (step S13). In a case where a reply “the search is required” is returned from the search necessity/unnecessity confirmation unit 13, the model checking execution unit 12 performs search of a subsequent state. When a reply “the search is not required” is returned, the model checking execution unit 12 omits the search of the subsequent state.

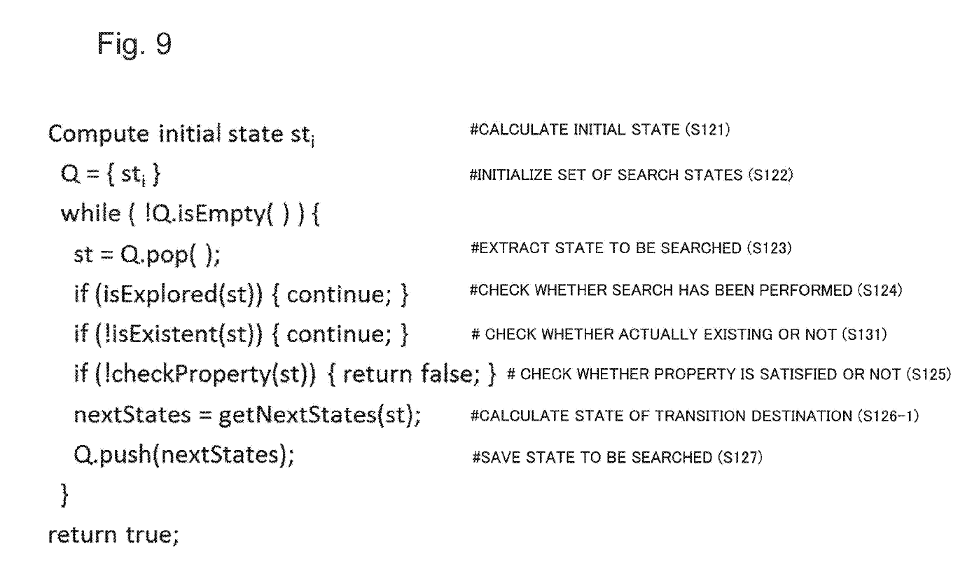

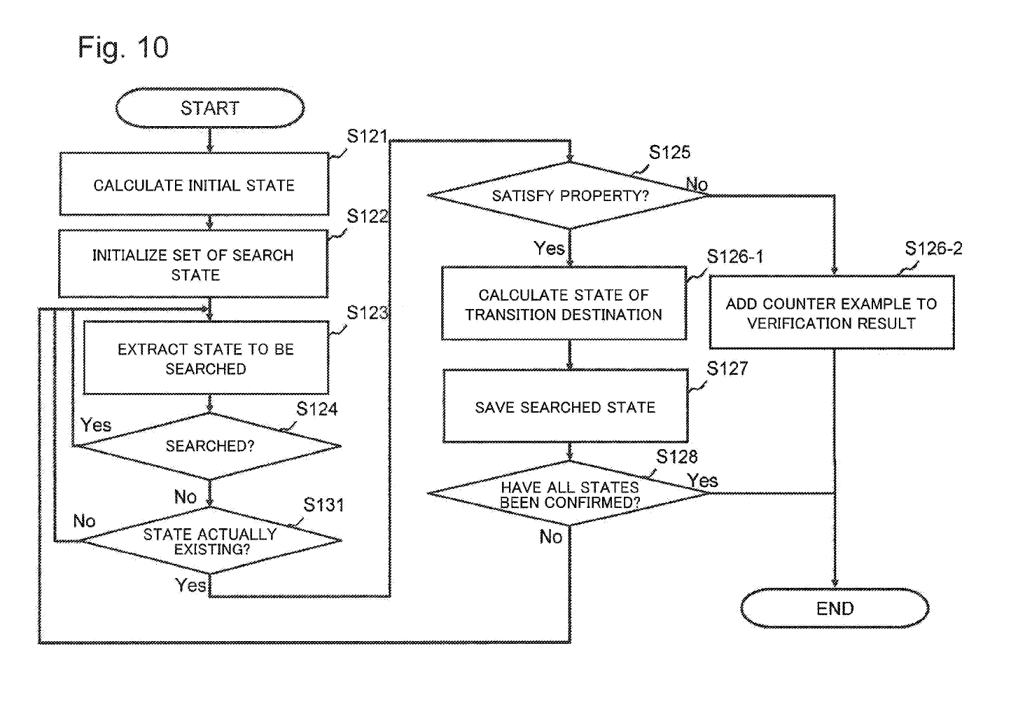

Hereinafter, the basic operation of the model checking of the network verification device 1 will be explained with reference to a sample code as shown in FIG. 9 and a flowchart of FIG. 10 equivalent to this sample code.

As shown in FIG. 9 (FIG. 10), first, the model checking execution unit 12 generates an initial state of the state transition model to be verified (step S121), and sets it a set of search states (step S122).

Subsequently, the model checking execution unit 12 selects and retrieves any one state from the set of the search candidate states (step S123). The model checking execution unit 12 checks whether the state has been searched or not, and when the state has been searched, step S123 is performed again (step S124).

On the other hand, when the extracted state has not been searched, the model checking execution unit 12 inquires of the search necessity/unnecessity confirmation unit 13 whether the state is to be searched or not. When the state is not to be searched, the processing in step S123 is performed again (step S131). On the other hand, in a case where a reply indicating that the state is to be searched is obtained from the search necessity/unnecessity confirmation unit 13, the model checking execution unit 12 checks whether the state satisfies the property or not. When the state does not satisfy the property, the model checking execution unit 12 generates verification result D12 having a counter example, and terminates the model checking (step S125).

On the other hand, in a case where the state satisfies the property, the model checking execution unit 12 calculates a subsequent state to which the state can be transited (step S126-1). The model checking execution unit 12 adds all the states obtained as a result of the calculation to the set of the search states (step S127).

The model checking execution unit 12 repeats step S123 to S127 (including step S131) until the set of the search states becomes empty.

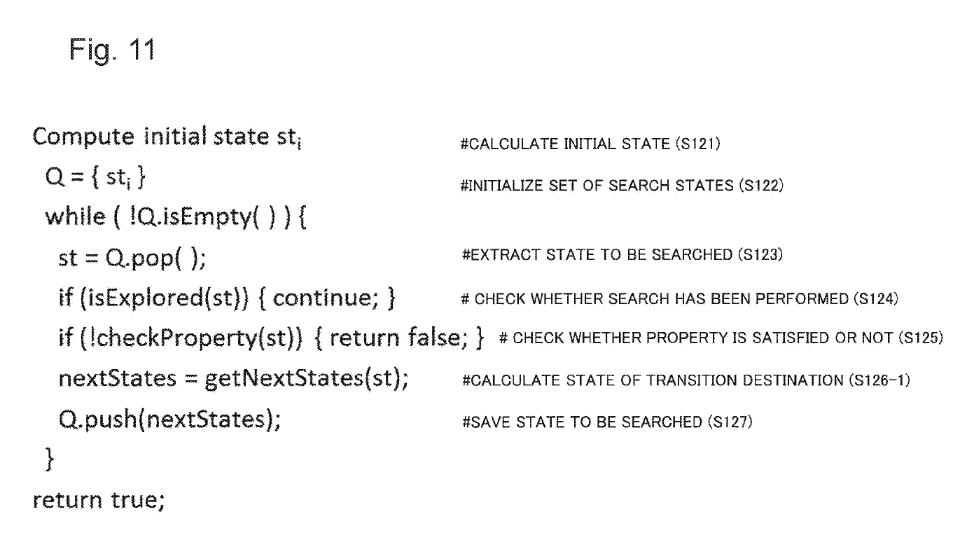

FIG. 11 is a sample code representing the basic operation of generally used model checking. As can be understood by comparing FIG. 9 and FIG. 11, in the generally used model checking, there does not exist any procedure corresponding to step S131 for confirming whether the state is to be searched.

In the model checking of the network verification device 1 according to the present exemplary embodiment, the content of the packet is not dealt with in a concrete manner, and therefore, a state that passes a transition path that could actually not occur (the search is not required) may be generated. In contrast, an inquiry to the search necessity/unnecessity confirmation unit 13 is performed (step S131), and therefore, the model checking can be performed without searching a state for which a search is not required (a difference 1 from the generally used model checking).

In the model checking of the network verification device 1 according to the present exemplary embodiment, the model checking of the OpenFlow network is performed while the content of the packet is not dealt with in a concrete manner. Therefore, the content of step S126-1 for calculating a subsequent state to which the state can be transited is also different from the algorithm of the generally used model checking (a difference 2 from the generally used model checking). Hereinafter, the detailed operation of step S126-1 will be explained.

The definition of the “state” in the model checking of the network verification device 1 will be explained. The state is defined as a combination of seven elements (T, S, C, R, P, M, Q). T is a set of terminals. An element t (tεT) of T has a variable sv indicating which operation in the operation sequence defined as the operation model of the terminal t is subsequently performed. S is a set of switches. An element s (sεS) of S has a variable E representing a set of flow entries installed in the switch. An element e (eεE) of E is a flow entry. The element e is defined as a combination (mr, af) including the value mr representing the content of a matching rule (matching condition) and the value af representing the content of the action field. C is a set of controllers. An element c (cεC) of C has a variable V representing a set of variables that are treated globally by each operation model of the controller c and a variable H representing a set of pieces of information related to the operation model (event handler) of the controller c. An element v (vεV) of V is one of variables globally treated by the operation model of the controller. The element v is defined as a combination (vn, vv) including the value vn representing the name of the variable and the value vv representing the value of the variable. An element h (hεH) of H is defined as a combination (hn, hc) including the value hn representing the name of an event handler and the value hc representing the number of times the event handler is executed. R is a set of pieces of constraint information. An element r (rεR) of R represents each pieces of constraint information. P is a set of packets. An element p (pεP) of P has a variable id representing the ID of a packet. M is a set of OpenFlow messages. An element m (mεM) of M has a variable mv representing the content of an OpenFlow message. Q is a set of communication ports. An element q (qεQ) of Q is a communication port achieved by an FIFO (First In, First Out) queue storing packets and OpenFlow messages. The above is the definition of the state of the model checking of the network verification device 1. Among them, those other than the variable H possessed by c (cεC) and the variable id possessed by p (pεP) are given to represent the situation of OpenFlow network which is to be verified. On the other hand, the variable H and the variable id are information prepared in an auxiliary manner in order to execute the model checking with the network verification device 1. They will be described in details in the explanation about an example of state transition actually using them.

Subsequently, the definition of the “state transition” in the model checking of the network verification device 1 will be explained. The state transition of the model checking of the network verification device 1 represents how the state of the network changes when any one of the terminals, the switch and the controller existing in the OpenFlow network to be verified executes operations in particular units. More specifically, the operations in particular units include the following six types.

1. Packet transmission of terminal
2. Packet reception of terminal
3. Application of flow entry of switch
4. Packet-In message transmission of switch
5. OpenFlow message reception of switch
6. Program execution of controller

By executing any one of the operations 1 to 6, the model checking execution unit 12 calculates a state to which any given state can transit (step S126-1), and adds the state to the set of search states (step S127). In a case where multiple state transitions are possible in any given state, the model checking execution unit 12 calculates each state of result obtained by executing any one of them (step S126-1), and adds all of them to the set of the search states (step S127). Hereinafter, the six types of operations will be respectively explained in details.

(1) The state transition with the packet transmission of the terminal will be explained. In the model checking of the model checking execution unit 12, in a case where the terminal has not completed execution of all the operation models of the terminal itself included in the verification information D11, the terminal can execute a packet transmission operation represented by the variable sv possessed by the terminal chosen from among the packet transmission operations defined in the operation models. In the state transition with the packet transmission of the terminal, first, the model checking execution unit 12 generates a packet p transmitted by the terminal t (tεT), and adds it to the set of packets P. Then, the model checking execution unit 12 allocates an ID to the packet p (a particular value is substituted into the variable id of p). At this occasion, as the allocated ID, the model checking execution unit 12 allocates an ID that does not overlap existing packets (an ID that can uniquely identify the packet) by referring the set of packets P. It should be noted that, as long as the packet can be uniquely identified, the packet ID may be allocated according to any method. For example, a method of allocating IDs may be performed according to a method including setting the first allocated ID to an integer value “1” and subsequently increasing the allocated value each time to allocate 2, 3, . . . (hereinafter, in the explanation, the IDs are considered to be allocated using such the method).

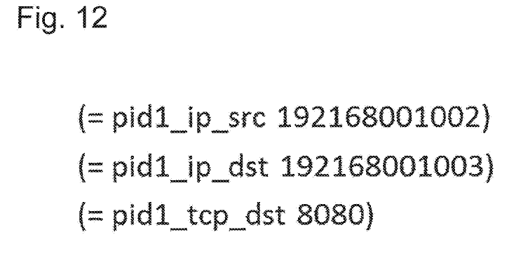

Subsequently, the model checking execution unit 12 refers to the content of a packet to be transmitted, which is defined in the operation model, and generates constraint information r indicating that the packet p satisfies the content and adds the constraint information r to the set of constraint information R. FIG. 12 illustrates constraint information which is to be added in a case where the ID of the transmitted packet is “1” when the packet transmission operation in the first line of FIG. 6 is executed. The ID of the packet is allocated so that the content of which packet is limited by the constraint information can be identified. As shown in FIG. 12, the ID of the packet (corresponding to the portion of “pid1_” of FIG. 12”) is given to the variable name used in the constraint information, so that this enables identifying the content of which packet is limited by the constraint information. However, the holding format of the constraint information is not limited to what is shown in FIG. 12 and may be in other formats as long as it can be processed in a mechanical manner and includes sufficient information for generating the constraint satisfaction problem D14 which is input to the constraint satisfaction problem resolving unit. Finally, the model checking execution unit 12 stores the packet p to the communication port q (qεQ) corresponding to the transmission destination. The model checking execution unit 12 derives the communication port q corresponding to the transmission destination from the connection relationship of the terminals, the switches, and the controllers constituting the network included in the verification information D11. In the subsequent storage processing of the packet or the OpenFlow message to the communication port, the model checking execution unit 12 is assumed to deriving an appropriate communication port on the basis of the connection relationship as shown in FIG. 3.

The subsequent state obtained as a result of the above procedure is defined as the transition destination state caused by the packet transmission of the terminal. The packet transmission operation that can be executed by a particular terminal in a particular state is no more than one (only the one expressed by the variable sv possessed by the terminal). Therefore, the transition destination state obtained from the packet transmission operation of the particular terminal is no more than one.

(2) Subsequently, a state transition caused by packet reception of the terminal will be explained. In the model checking of the model checking execution unit 12, the terminal can execute the packet reception operation in a case where one or more packets are stored in the packet reception communication ports of the terminal itself. In the state transition caused by the packet transmission of the terminal, a packet p (pεP) of which stored time to q is the oldest is retrieved from the packet reception communication port q (qεQ) of the terminal t (tεT) storing one or more packets, and the packet p is discarded. The state obtained as a result of this is defined as the transition destination state caused by the packet reception of the terminal. The number of packet reception operations that can be executed by a particular terminal in a particular state is no more than the number of packet reception communication ports of the terminal (in a case where packets are stored in all the packet reception communication ports of the terminal). Therefore, the number of transition destination states obtained from the packet transmission operation of a particular terminal is no more than the number of packet reception communication ports of the terminal.

(3) Subsequently, a state transition caused by application of flow entry of the switch will be explained. In the model checking of the model checking execution unit 12, the switch can execute the flow entry application operation in a case where one or more packets are stored in the packet reception communication ports of the switch itself. In the flow entry application operation of the switch, first, a packet p (pεP) of which stored time to q is the oldest is retrieved from the packet reception communication port q (qεQ) of the switch s (sεS) storing one or more packets. Subsequently, the model checking execution unit 12 selects a single flow entry e (eεE) to be applied. Then, the model checking execution unit 12 refers to the content of the matching rule mr of the id of the retrieved packet p and the selected flow entry e. The model checking execution unit 12 generates constraint information r indicating that the retrieved packet p satisfies the content of the matching rule mr, and adds the constraint information r to the constraint information R.

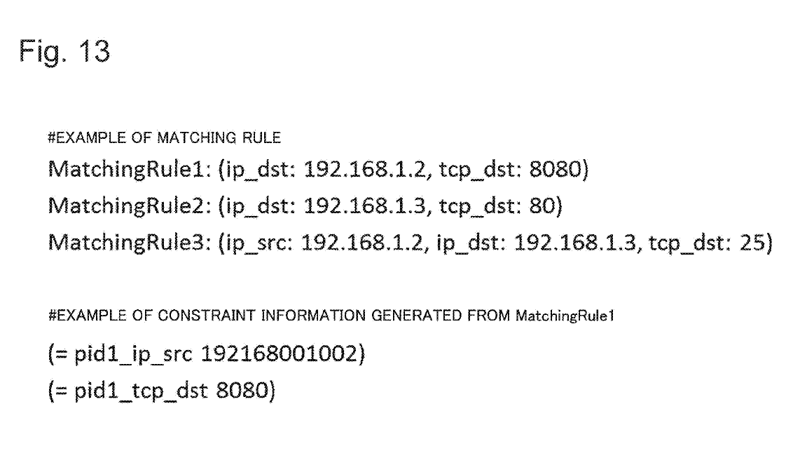

For example, a case where the switch s has a flow entry having the matching rules shown in the upper portion of FIG. 13 will be explained. In this case, when the ID of the retrieved packet p is “1” and the flow entry defining the matching rule MatchingRule1 in the upper portion of FIG. 13 is to be applied, then, the model checking execution unit 12 generates constraint information as shown in the lower portion of FIG. 13, and adds the constraint information to the set of constraint information R. Finally, an operation defined in the action field af of the selected flow entry e is executed. Hereinafter, a case where the content change operation (Modify-Field) of the packet p is defined in the action field af will be explained. In this case, the model checking execution unit 12 allocates a new ID to the packet p, thereafter generates constraint information r indicating that the packet p satisfies the content after the content change operation, and adds the constraint information r to the set of constraint information R. That is, when there is a change in the content of the packet, previous constraint information becomes unrelated to the packet, and there occurs inconsistency between the constraint information before the change and after the change, and therefore, this process is performed in order to prevent occurrence of inconsistency by treating them as different packets. The state obtained as a result of the above procedure is defined as the transition destination state caused by the flow entry application of the switch. The number of flow entry application operations that can be executed on a particular packet by a particular switch in a particular state is no more than the number of flow entries possessed by the switch. Therefore, the number of flow entry application operations that can be executed by a particular switch in a particular state is no more than the number of flow entries possessed by the switch multiplied by the number of packet reception ports of the switch (in a case where packets are stored in all the packet reception communication ports of the switch). Therefore, the number of transition destination states obtained from the flow entry application operation of the particular switch is no more than the number of flow entries possessed by the switch multiplied by the number of packet reception ports of the switch.

(4) Subsequently, a state transition caused by Packet-In message (which is one of OpenFlow messages) transmission of the switch will be explained. In the model checking of the model checking execution unit 12, the switch can execute the Packet-In message transmission operation in a case where one or more packets are stored in the packet reception communication ports of the switch itself. In the Packet-In message transmission operation of the switch, first, a packet p (pεP) of which stored time to q is the oldest is retrieved from the packet reception communication port q (qεQ) of the switch s (sεS) storing one or more packets. Subsequently, the model checking execution unit 12 generates constraint information r indicating that the packet p does not satisfy the matching rules mr of all the flow entries e (eεE) possessed by the switch s, and adds the constraint information r to the constraint information R.

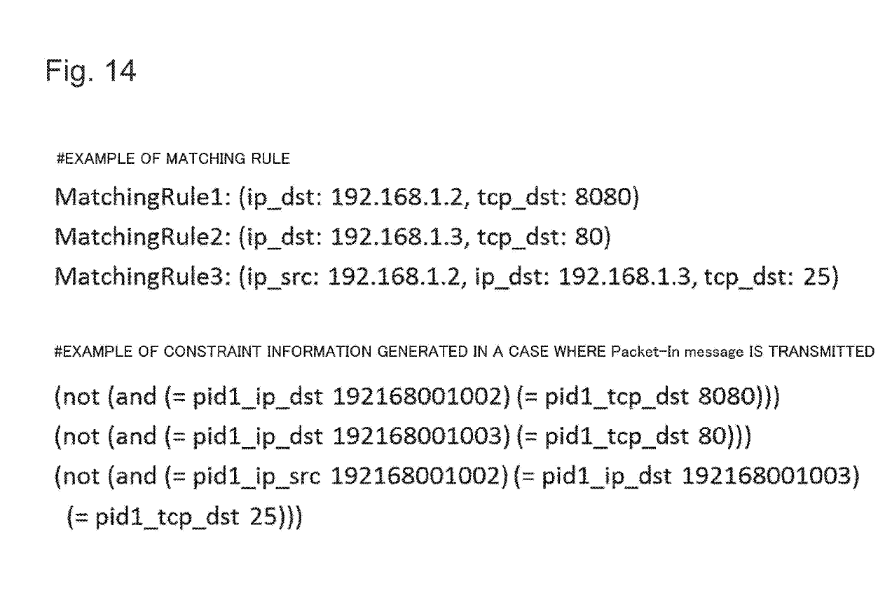

For example, when the switch s has a flow entry having the matching rules shown in the upper portion of FIG. 14 and the ID of the retrieved packet p is “1”, then, the model checking execution unit 12 generates the constraint information as shown in the lower portion of FIG. 14, and adds the constraint information to the set of constraint information R. Finally, the model checking execution unit 12 stores a Packet-In message including information about the packet p to the communication port q (qεQ) corresponding to the controller. The state obtained as a result of this is defined as the transition destination state caused by the Packet-In message transmission of the switch. The number of Packet-In message transmission operations that can be executed by a particular switch in a particular state is no more than the number of flow entries possessed by the switch. Therefore, the number of flow entry application operations that can be executed by a particular switch in a particular state is no more than the number of packet reception ports of the switch (in a case where packets are stored in all the packet reception communication ports of the switch). Therefore, the number of transition destination states obtained from the Packet-In message transmission operation of the particular switch is no more than the number of packet reception ports of the switch.

(5) Subsequently, a state transition caused by OpenFlow message reception of the switch will be explained. In the model checking of the model checking execution unit 12, the switch can execute the OpenFlow message reception operation in a case where one or more OpenFlow messages are stored in the OpenFlow message reception communication ports of the switch itself. In the OpenFlow message reception operation of the switch, first, an OpenFlow message m (mεM) of which stored time to q is the oldest is retrieved from the OpenFlow message reception communication port q (qεQ) of the switch s (sεS) storing one or more OpenFlow messages. Subsequently, the model checking execution unit 12 refers to the content mv of the OpenFlow message m, and executes operation corresponding to mv in accordance with the specification of the OpenFlow. The state obtained as a result of this is defined as the transition destination state caused by the OpenFlow message reception of the switch. The number of OpenFlow message reception operations that can be executed by a particular switch in a particular state is no more than the number of OpenFlow message reception ports of the switch (in a case where OpenFlow messages are stored in all the OpenFlow message reception communication ports of the switch). Therefore, the number of transition destination states obtained by the OpenFlow message reception operation of the particular switch is no more than the number of OpenFlow message reception ports of the switch.

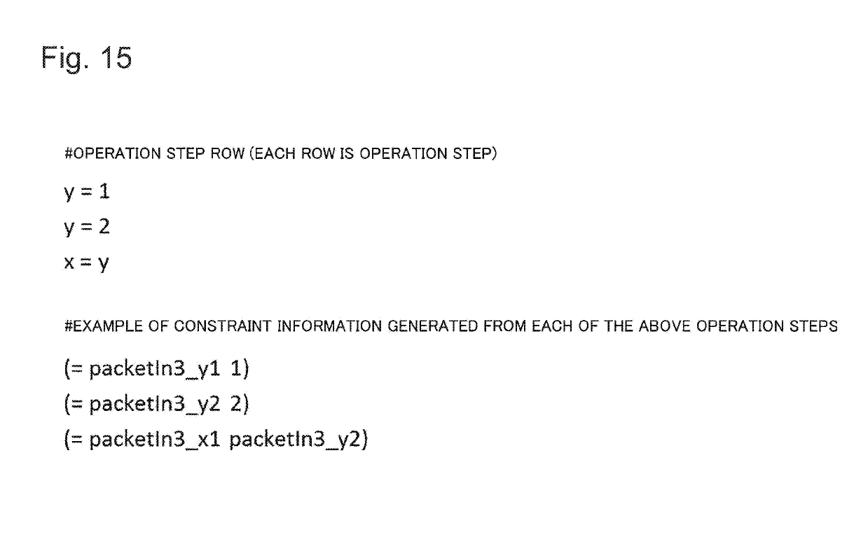

(6) Subsequently, a state transition caused by program execution of the controller will be explained. In the model checking of the model checking execution unit 12, the controller can execute the program execution operation in a case where one or more OpenFlow messages are stored in the OpenFlow message reception communication ports of the controller itself. In the program execution operation of the controller, first, an OpenFlow message m (mεM) of which stored time to q is the oldest is retrieved from the OpenFlow message reception communication port q (qεQ) of the controller c (cεC) storing one or more OpenFlow messages. Subsequently, the model checking execution unit 12 refers to the content mv of the OpenFlow message m, and executes operation corresponding to mv chosen from event handlers defined in the operation model of the controller c included in the verification information D11 (if not defined, the default operation specified in the OpenFlow specification is executed. In the execution of the event handler, for each operation step of the event handler (the minimum operation unit such as, e.g., a transition action in the state transition diagram, a statement in the programming language, and the like), constraint information indicating that the content of the operation step is satisfied is generated and added to the set of constraint information R. However, in a case where a variable is referred to and substituted in the operation step, the variable name is replaced so that the name of the event handler and the number of times of executions are given to the variable name by referring to hn and hc of the event handler in the generated constraint information to perform single assignment. For example, in a case where the name of the event handler including the operation step rows is “packetIn” in the operation step rows as shown in the upper portion of FIG. 15, and the number of times of executions is three (the third time), the model checking execution unit 12 respectively generates constraint information obtained by replacing the variable names as shown in the lower portion of FIG. 15, and adds the constraint information to the set of constraint information R.

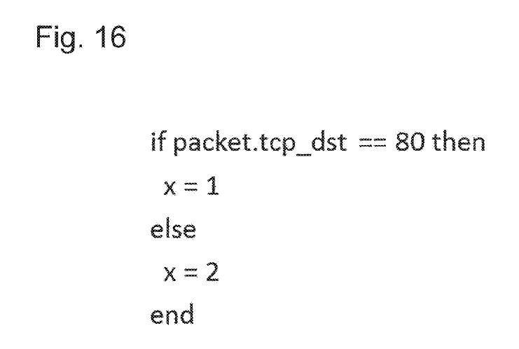

It should be noted that the above replacing of the variable names are performed so that the content of which variable is used or limited by the constraint information can be identified. The example of FIG. 15 is configured so that the content of which variable is used or limited by the constraint information can be identified by the variable names. However, the holding format of the constraint information is not limited to what is shown in FIG. 15 as long as it can be processed in a mechanical manner, and may include sufficient information for generating the constraint satisfaction problem D14 which is input to the constraint satisfaction problem resolving unit. The state obtained as a result of the above procedure is defined as the transition destination state of the program execution of the controller. However, in a case where the content mv of the OpenFlow message m is to refer to the content of a particular packet (such as a Packet-In message), the event handler is not simply executed, and instead, symbolic execution of the event handler is performed while the content of the packet p, which is referred to, is treated as unspecified. Then, all the states obtained as a result of this is adopted as the transition destination states caused by the program execution of the controller. More specifically, this means that, in a case where the execution result of the event handler is changed in accordance with the content of the packet p, all the results thereof are derived as the transition destination states. For example, as shown in FIG. 16, in a case where the branch destination is changed (the execution result of the event handler also changes as a result) in accordance with the content of the packet (the destination TCP port number in FIG. 16), the event handler is executed in a separate manner upon branching into each branch destination (then clause and else clause of if statement in FIG. 16). Then, all the states obtained from the result of which executions are completed are derived as the transition destination states. In general, the branch of the event handler dependent upon the content of the packet is not necessarily in one portion. For this reason, in a case where there are multiple such branches, the transition destination state is derived by performing execution of the event handler in a form of covering all the branches (more specifically, performing symbolic execution). In the operation step of the symbolic execution of the event handler referring to the content of a particular packet, the following operation is executed in a case where the content of the packet p is changed. More specifically, like the content change operation of the packet with the switch, a new ID is allocated to the packet p, and thereafter, constraint information r indicating that the packet p satisfies the content after the content change operation is generated, and the generated constraint information is added to the set of constraint information R. All the states obtained as a result of the above procedure are defined as the transition destination states caused by the program execution of the controller.

In the model checking of the model checking execution unit 12, the operation for calculating a state to which any given state can transited (transition destination state) (step S126-1 of FIG. 9 (FIG. 10)) is achieved by calculating the above six types of state transitions for each of the terminals, the switches, and the controllers constituting the network.

FIG. 8 is referred to again, and, first, in the search necessity/unnecessity confirmation unit 13, the constraint satisfaction problem generation unit 131 receives an inquiry from the model checking execution unit 12. The constraint satisfaction problem generation unit 131 generates the constraint satisfaction problem D14 from the constraint information D13 received at that occasion (step S14 of FIG. 8). Subsequently, the constraint satisfaction problem resolving unit 132 derives presence derives a presence or absence D15 of the solution by solving the constraint satisfaction problem D14 (step S15 of FIG. 8). The constraint satisfaction problem resolving unit 132 gives a requirement or non-requirement D16 of the search to the model checking execution unit 12 in accordance with the presence or absence D15 of the solution (step S16 of FIG. 8).

More specifically, the constraint satisfaction problem generation unit 131 generates the constraint satisfaction problem D14 by converting the constraint information D13 into the input format of the constraint satisfaction problem resolving unit 132. For example, processing is performed to convert the constraint information D13 as shown in FIG. 12 into the constraint satisfaction problem D14 as shown in FIG. 7 (the input format of Ver. 1.0.37 of SMT solver Yices). As can be understood by comparing FIG. 12 and FIG. 7, when the constraint information D13 is held in a format similar to the format of the constraint satisfaction problem D14 in advance, the conversion thereof is easy. For example, in the example as shown in FIG. 12 and FIG. 7, a declaration portion of the variables using reserved word “define” (the upper three lines in FIG. 7) is added to the constraint information D13, and the conversion can be performed by just declaring the constraint information as the constraint expressions by using the reserved word “assert” (the lower three lines in FIG. 7). The constraint satisfaction problem resolving unit 132 solves the constraint satisfaction problem D14, and derives a presence or absence D15 of the solution. In a case where there exists a solution, the constraint satisfaction problem resolving unit 132 returns a reply “the search is required” to the model checking execution unit 12 as a requirement or non-requirement D16 of the search. In a case where there does not exist any solution, the constraint satisfaction problem resolving unit 132 returns a reply “the search is not required” to the model checking execution unit 12 as a requirement or non-requirement D16 of the search. When the model checking execution unit 12 receives the reply “the search is required” as the requirement or non-requirement D16 of the search, the model checking execution unit 12 performs the search of the subsequent state (step S125 and subsequent steps in FIG. 9 (FIG. 10)). When the model checking execution unit 12 receives the reply “the search is not required”, step S123 of FIG. 9 (FIG. 10) is performed again without performing the search of the state.

The verification result output unit 14 outputs a verification result D12 including whether the property is satisfied or not and a counter example indicating that the property is not satisfied in a case where the property is not satisfied, which is the output of the model checking execution unit 12 (step S17).

The user confirms the result which is output in step S17 (step S18).

As explained above, according to the present exemplary embodiment, the exhaustive verification of the OpenFlow network can be carried out in an efficient manner, and problems can be detected without exception. The reason for this is that, when the model checking of the OpenFlow network, which is to be verified, is performed, the network verification device 1 does not hold a concrete content of a packet transmitted in the OpenFlow network, and performs the state transition without depending on the content. Therefore, efficient model checking can be carried out without considering the difference of the contents of the packets transmitted by the terminals in the OpenFlow network. When the content of a packet is not dealt with in a concrete manner, a state that passes a transition path that could actually not occur (the search is not required) may be generated. For this problem, the constraint information required to determine whether the state transition that could actually occur or not is held in the state during the state transition, and the search necessity/unnecessity confirmation unit 13 confirms whether the transition path of the state in the past could actually occur or not by using the constraint information, and searches only the state that passes a transition path that could actually occur (the search is required). Therefore, the model checking can be carried out by omitting the state for which the search of the subsequent state is not required.

Subsequently, a second exemplary embodiment of the present invention for performing verification operation of a network other than the OpenFlow network will be explained in details with reference to drawings. Hereinafter, the same portions as those of the first exemplary embodiment are omitted, and only different portions will be explained.

[Explanation about Configuration]

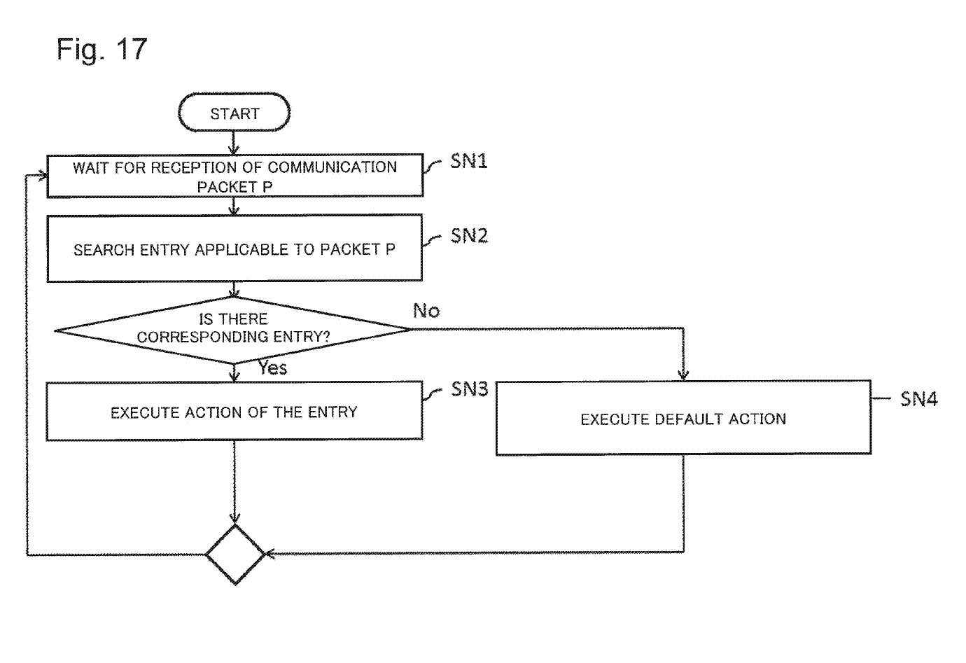

The configuration of the second exemplary embodiment of the present invention will be explained in details with reference to FIG. 2 again. A verification information input unit 11 of the second exemplary embodiment of the present invention receives, as an input, verification information D11 for defining a connection relationship of terminals and network devices constituting the network, each operation model of the terminal and the controller, and a property that is to be satisfied by the network. The operation model of the network can use the same one as the first exemplary embodiment. FIG. 17 is an example of the operation model of a network device that is assumed in the second exemplary embodiment of the present invention. In the example of FIG. 17, the network device waits for reception of a communication packet P (step SN1), and when the network device receives the packet, the network device searches an entry applicable to the destination and the like of the reception packet P from among the entries that are set and implemented in the device itself (step SN2). When there is an entry applicable to the destination and the like of the reception packet, the network device executes the processing content defined in the entry (step SN3). On the other hand, there is no entry applicable to the destination and the like of the reception packet P, the network device executes processing that are set and implemented as the default operation (step SN4). The network device includes an operation of repeating the above. In the present exemplary embodiment, the property may not be necessarily defined in the verification information D11. In a case where the property is not defined, a typical property is verified, and thereafter, the entire network verification device performs an operation in such a manner as if the typical property is defined in the verification information D11.

[Explanation about Operation]

Subsequently, the operation of the second exemplary embodiment of the present invention will be explained in details. The difference in the operation of the second exemplary embodiment of the present invention from the operation of the first exemplary embodiment of the present invention is only the definition of the state and the transition of the model checking with the model checking execution unit 12. The basic operation of the model checking with the operation and model checking execution unit 12 in the other portion (portion corresponding to FIG. 9 (FIG. 10)) is the same as the first exemplary embodiment.

First, the definition of the “state” in the model checking of the network verification device 1 will be explained. In the present exemplary embodiment, the state is defined as a combination of five elements (T, N, R, P, Q). T is a set of terminals. An element t (tεT) of T has a variable sv indicating which operation in the operation sequence defined as the operation model of the terminal t is subsequently performed.

N is a set of network devices. An element n (nεN) of N has a variable E representing a set of processing entries that are set and implemented in the network device. An element e (eεE) of E is a packet processing entry. The element e is is defined as a combination (mr, af) including the value mr representing an application condition and the value af representing the content of the application processing.

R is a set of pieces of constraint information. An element r (rεR) of R represents each pieces of constraint information.

P is a set of packets. An element p (pεP) of P has a variable id representing the ID of a packet.

Q is a set of communication ports. An element q (qεQ) of Q is a communication port achieved by an FIFO (First In, First Out) queue storing packets. The above is the definition of the state of the model checking of the network verification device 2. Among them, those other than the id possessed by p (pεP) are given to represent the situation of the network which is to be verified. On the other hand, the variable id is information prepared in an auxiliary manner in order to execute the model checking with the network verification device 1. The difference therebetween will be described in details in the explanation about an example of state transition actually using them.

Subsequently, the definition of the “state transition” in the model checking of the network verification device 1 according to the present exemplary embodiment will be explained. The state transition of the model checking of the network verification device 1 represents how the state of the network changes when any one of the terminals and the network devices existing in the network to be verified executes operations in particular units. More specifically, the operations in particular units include the following four types.

1. Packet transmission of terminal
2. Packet reception of terminal
3. Processing entry application which is not the default of network device
4. Processing entry application which is the default of network device

By executing any one of the operations, the model checking execution unit 12 calculates a state to which any given state can transit (step S126-1 of FIG. 9 (FIG. 10)), and adds the state to the set of search states (step S127 of FIG. 9 (FIG. 10)). In a case where multiple state transitions are possible in any given state, the model checking execution unit 12 calculates each state of result obtained by executing any one of them (step S126-1), and adds all of them to the set of the search states (step S127). Among the four types of operations, the packet transmission of the terminal and the packet reception of the terminal are the same as those of the first exemplary embodiment, and therefore detailed explanation thereabout is omitted. Hereinafter, the remaining two types of operations will be respectively explained in details.

First, a state transition by a state transition which is not the default of the network device will be explained. In the model checking of the model checking execution unit 12, the terminal can execute the non-default processing entry application operation in a case where one or more packets are stored in the packet reception communication ports of the network device itself. In the non-default processing entry application operation which is not the default of the network device, first, the model checking execution unit 12 retrieves a packet p (pεP) of which stored time to q is the oldest from the packet reception communication port q (qεQ) of the network device n (nεN) storing one or more packets. Subsequently, the model checking execution unit 12 selects processing entry e (eεE) applied to the packet p. Then, the model checking execution unit 12 refers to the content of the application condition mr of the selected processing entry e and the id of the retrieved packet p, and generates constraint information r indicating that the retrieved packet p satisfies the content of the application condition mr, and adds the constraint information r to the constraint information R. Finally, the model checking execution unit 12 executes the operation defined in the application processing af of the selected processing entry e. In this case, in a case where the content change operation of the packet p is defined in the application processing af, the model checking execution unit 12 allocates a new ID to the packet p, thereafter, generates constraint information r indicating that the packet p satisfies the content after the content change operation, and adds the generated constraint information to the set of constraint information R. The state obtained as a result of the above procedure is defined as the transition destination state caused by the processing entry application which is not the default of the network device. The number of non-default processing entry application operations that can be executed by a particular network device on a particular packet in a particular state is no more than the number of non-default processing entries possessed by the network device. Therefore, the number of non-default processing entry application operations that can be executed by a particular network device in a particular state is no more than the number of non-default processing entries possessed by the network device multiplied by the number of packet reception ports of the network device (in a case where packets are stored in all the packet reception communication ports of the network device). Therefore, the number of transition destination states obtained from the non-default processing entry application operation of the particular network device is no more than the number of processing entries possessed by the network device multiplied by the number of packet reception ports of the network device.

Subsequently, a state transition caused by the default processing entry application of the network device will be explained. In the model checking of the model checking execution unit 12, the network device can execute the default processing entry application operation in a case where one or more packets are stored in the packet reception communication ports of the network device itself. In the default processing entry application operation of the network device, first, the model checking execution unit 12 retrieves a packet p (pεP) of which stored time to q is the oldest is retrieved from the packet reception communication port q (qεQ) of the network device n (nεN) storing one or more packets. Subsequently, the model checking execution unit 12 generates constraint information r indicating that the packet p does not satisfy the application conditions mr of all the processing entries e (eεE) possessed by the network device n, and adds the constraint information r to the constraint information R. Finally, the model checking execution unit 12 executes the operation defined in the application processing of of the default processing entry e. In this case, in a case where the content change operation of the packet p is defined in the application processing af, the model checking execution unit 12 allocates a new ID to the packet p, thereafter, generates constraint information r indicating that the packet p satisfies the content after the content change operation, and adds the generated constraint information to the set of constraint information R. The state obtained as a result of the above procedure is defined as the transition destination state caused by the processing entry application which is the default of the network device. The number of default processing entry application operations that can be executed by a particular network device in a particular state is no more than the number of packet reception ports of the network device (in a case where packets are stored in all the packet reception communication ports of the network device). Therefore, the number of transition destination states obtained from the default processing entry application operation of the particular network device is no more than the number of packet reception ports of the network device.

In the model checking of the model checking execution unit 12 according to the second exemplary embodiment of the present invention, the operation for calculating a state to which any given state can transited (transition destination state) (step S126-1 of FIG. 9 (FIG. 10)) is achieved by calculating the above four types of state transitions for each of the terminals and the network devices constituting the network.

As explained above, according to the present exemplary embodiment, the exhaustive verification of the networks other than the OpenFlow network can be carried out in an efficient manner, and problems can be detected without exception. In the present exemplary embodiment, the reason for this is also because a concrete content of a packet transmitted in the network is not held, and the state transition is performed without depending on the content, and the model checking is carried out without searching a state of which search is not required.

### Third Exemplary Embodiment

Subsequently, the third exemplary embodiment of the present invention obtained by applying an improvement to the user interface of the above first and second exemplary embodiments will be explained in details with reference to drawings. Hereinafter, the same portions as those of the first exemplary embodiment are omitted, and only different portions will be explained.

[Explanation about Configuration]

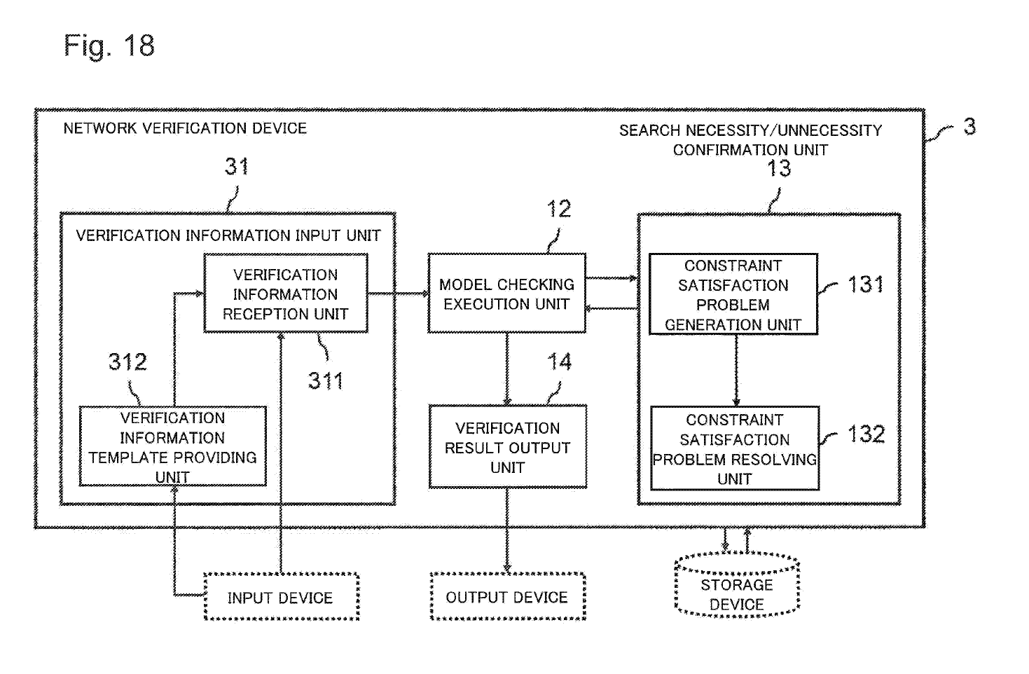

FIG. 18 is a figure illustrating a configuration of a network verification device according to the third exemplary embodiment of the present invention. A verification information input unit 31 according to the present exemplary embodiment includes a verification information reception unit 311 and a verification information template providing unit 312. The verification information reception unit 311 receives, as an input, verification information D11 for defining a connection relationship of all the terminals, switches, and controllers constituting the network, each operation model of the terminal and the controller, and a property that is to be satisfied by the network.

When an input of verification information is received from the user, the verification information template providing unit 312 provides a typical template (template) for a part or all of the verification information D11, and the user selects a template. Therefore, the verification information template providing unit 312 uses this as a part of all of the verification information D11, and has a function of capable of inputting this to the verification information reception unit 311.

[Explanation about Operation]

When the user generates the verification information D11 in step S11 of FIG. 8, the user selects desired some templates from the verification information template providing unit 312, and completes the verification information D11 by using them. The user inputs the completed verification information D11 into the verification information reception unit 311. It is to be understood that, like the first exemplary embodiment, the user may generate the verification information D11 without using the template at all and may input the verification information D11. The other operations are the same as those of the first exemplary embodiment of the present invention, and are therefore omitted.

As explained above, according to the present exemplary embodiment, the burden imposed on the user to generate the verification information D11 when using the network verification device can be reduced. Further, according to the present exemplary embodiment, the efficiency of the entire verification can also be improved as a result of the reduction of the burden of the user. It is to be understood that the configuration of the present exemplary embodiment can also be applied to the configuration of the second exemplary embodiment for verifying a network other than the OpenFlow network.

Each exemplary embodiment of the present invention has been hereinabove explained, but the present invention is not limited to the above exemplary embodiment, and further modifications, replacements, and adjustments can be applied without deviating from the basic technical concept of the present invention. For example, the configuration of the device shown in each drawing is an example for heling the understanding of the present invention, and is not limited to the configuration shown in these drawings.

Finally, a preferred aspect of the present invention will be summarized.

### [First Aspect]

(see the network verification device based on the above first viewpoint)

### [Second Aspect]

The network verification device according to the first aspect, wherein configuration information about a network including a terminal, an OpenFlow switch and an OpenFlow controller and an operation model of the terminal and the OpenFlow controller are defined in the verification information.

### [Third Aspect]

The network verification device according to the first or second aspect, wherein the search necessity/unnecessity confirmation unit includes:

a constraint satisfaction problem generation unit which receives, from the model checking execution unit, information (constraint information) about a constraint that is to be satisfied when passing a past transition path of the state, and generates a constraint satisfaction problem from the constraint information; and

a constraint satisfaction problem resolving unit which determines whether the transition path could actually occur or not by deriving a solution of the constraint satisfaction problem, and confirms whether the search of the state is required or not.

### [Fourth Aspect]

The network verification device according to any one of the first to the third aspect, wherein a property that is to be satisfied by a network to be verified can be defined and inputted by a user as a part of the verification information.

### [Fifth Aspect]

The network verification device according to any one of the first to the fourth aspect, wherein the verification information input unit provides, to a user, a template defining a typical content with regard to a part or all of the verification information, and receives an input of at least a part of the verification information in response to a selection of the template.

### [Sixth Aspect]

(see the network verification method based on the above second viewpoint)

### [Seventh Aspect]

(see the program based on the above third viewpoint)

It should be noted that the sixth and the seventh aspect can be expanded into the second to the fifth aspect like the first aspect.

It is to be understood that the disclosure of each of the above NPLs is incorporated herein by reference. Further, the exemplary embodiments or the example can be changed and adjusted on the basis of the basic technical concept thereof within the frame of the entire disclosure (including claims) of the present invention. Various combinations or selections of various disclosed elements (including each element of each claim, each element of each exemplary embodiment or example, each element of each drawing, and the like) can be made within the frame of the entire disclose of the present invention. More specifically, it is to be understood that the present invention includes various kinds of modifications and corrections that could be made by a person skilled in the art in accordance with the entire disclose including claims and the technical concept. In particular, with regard to the numerical value ranges described in this specification, it is to be understood that any given numerical value or a smaller range included in the range is interpreted as being described in a specific manner even if it is not specifically described.

### REFERENCE SIGNS LIST

1, 1A, 3 network verification device
11, 31 verification information input unit
12 model checking execution unit
13 search necessity/unnecessity confirmation unit
14 verification result output unit
131 constraint satisfaction problem generation unit
132 constraint satisfaction problem resolving unit
311 verification information reception unit
312 verification information template providing unit

1. A network verification device comprising:
a verification information input unit that receives an input of verification information that defines a configuration of a network to be verified and an operation model of a device included in the network;
a model checking execution unit which, in a model checking using the verification information, performs a state transition without concretely dealing with a content of a packet from a terminal connected to the network, sends information relating to a past transition path of each state to a search necessity/unnecessity confirmation unit before a state search of a subsequent state, and performs the model checking while inquiring whether or not the search of the subsequent state can be omitted or not
the search necessity/unnecessity confirmation unit which, based on the information relating to the past transition path of the state and received from the model checking execution unit, determines whether or not the search of the subsequent state can be omitted, and responds as to whether or not the search of the subsequent state can be omitted; and
a verification result output unit which, based on an output from the model checking execution unit, outputs a result of a verification.

2. The network verification device according to claim 1, wherein configuration information about a network including a terminal, an OpenFlow switch and an OpenFlow controller and an operation model of the terminal and the OpenFlow controller are defined in the verification information.

3. The network verification device according to claim 1, wherein the search necessity/unnecessity confirmation unit comprises:
a constraint satisfaction problem generation unit which receives, from the model checking execution unit, information (constraint information) about a constraint that is to be satisfied when passing a past transition path of the state, and generates a constraint satisfaction problem from the constraint information; and
a constraint satisfaction problem resolving unit which determines whether the transition path could actually occur or not by deriving a solution of the constraint satisfaction problem, and confirms whether the search of the state is required or not.

4. The network verification device according to claim 1, wherein a property that is to be satisfied by a network to be verified can be defined and inputted by a user as a part of the verification information.

5. The network verification device according to claim 1, wherein the verification information input unit provides, to a user, a template defining a typical content with regard to a part or all of the verification information, and receives an input of at least a part of the verification information in response to a selection of the template.

6. A network verification method comprising:
receiving an input of verification information that defines a configuration of a network to be verified and an operation model of a device included in the network;
performing a model checking by performing a state transition without concretely dealing with a content of a packet from a terminal connected to the network by using the verification information; and
outputting a verification result of a network to be verified based on a result of the model checking,
wherein a determination is made as to whether search of the subsequent state can be omitted or not based on information relating to a past transition path of each state before a state search of a subsequent state in the model checking, and the search of the state that is determined to be able to be omitted is omitted.

7. The network verification method according to claim 6, wherein a determination is made as to whether a search of the state can be omitted or not by:
receiving, from the model checking execution unit, information (constraint information) about a constraint that is to be satisfied when passing a past transition path of the state, and generating a constraint satisfaction problem from the constraint information; and
determining whether the transition path could actually occur or not by deriving a solution of the constraint satisfaction problem, and confirming whether the search of the state is required or not.

8. A non-transitory computer readable storage medium storing a program for causing a computer to execute:
processing for receiving an input of verification information that defines a configuration of a network to be verified and an operation model of a device included in the network;
processing for performing a model checking by performing a state transition without concretely dealing with a content of a packet from a terminal connected to the network by using the verification information;
processing for outputting a verification result of a network to be verified based on a result of the model checking; and
further, processing for making a determination as to whether search of each state can be omitted or not based on information relating to a past transition path of each state before a state search of a subsequent state in the model checking, and omitting the search of the state that is determined to be able to be omitted.

9. The non-transitory computer readable storage medium according to claim 8, wherein a determination is made as to whether a search of the state can be omitted or not by using:
processing for receiving, from the model checking execution unit, information (constraint information) about a constraint that is to be satisfied when passing a past transition path of the state, and generating a constraint satisfaction problem from the constraint information; and
processing for determining whether the transition path could actually occur or not by deriving a solution of the constraint satisfaction problem, and confirming whether the search of the state is required or not.
